(19) United States
(12) Patent Application Publication
(10) Pub. No.: US 2006/0106475 A1
(43) Pub. Date: May 18, 2006

(54) Local and distributed systems for coupling automation design

(76) Inventors: Jon R. Mancuso, Catonsville, MD (US); Trevor D. Lewis, Crownsville, MD (US); Charles A. Sakers, Elkridge, MD (US); Michael T. D'Angelo, Edgewater, MD (US); Parthiv R. Amin, Ellicott City, MD (US)

Correspondence Address: HARNESS, DICKEY & PIERCE, P.L.C., P.O. BOX 828, BLOOMFIELD HILLS, MI, 48303, US

(21) Appl. No.: 11/101,371

(22) Filed: Apr. 7, 2005

Related U.S. Application Data
(60) Provisional application No. 60/623,152, filed on Oct. 28, 2004.

(51) Int. Cl. G06F 19/00

(52) U.S. Cl. 700/97; 703/1

(57) ABSTRACT

A system for designing a set of coupling components for coupling driving and driven shafts comprises an input module that provides a user interface for entering user input including one or more design parameters and/or user selections. A coupling selection and design module attempts to design at least one set of coupling components that meet the design parameters based on the user selections. An output module generates a coupling design specification file based on a selected one of the sets of coupling components from the coupling selection and design module.

### CROSS-REFERENCE TO RELATED APPLICATIONS

This application claims the benefit of U.S. Provisional Application No. 60/623,152, filed on Oct. 28, 2004. The disclosure of the above application is incorporated herein by reference in their entirety.

### FIELD OF THE INVENTION

The present invention generally relates to design of mechanical couplings for joining driving and driven shafts in mechanical and electromechanical systems, and relates in particular to a coupling automation program serving as a combination of an expert system and a configurator tool for designing couplings.

### BACKGROUND OF THE INVENTION

Mechanical couplings are typically employed to join driving and driven shafts in mechanical and electromechanical systems. While there are a wide variety of coupling styles that are particular to specific applications, a specific type of coupling will be described herein for illustration purposes. In some applications, the driving shaft is connected to a driving hub or rigid. An adapter connects the driving rigid to a driving-side adapter, which is connected by a spacer to a driven-side adapter. The driven-side adapter is connected by a driven hub or rigid to a driven shaft.

The coupling is designed to handle a predetermined amount of horsepower and/or torque, which may be a service factor ratio higher than a normal horsepower. When the predetermined amount of horsepower is exceeded, the coupling is designed to fail. If the coupling does not fail, damage may occur to the driving and/or driven shafts and/or to equipment that is connected to the driving and/or driven shafts.

Manufacturers of mechanical and electromechanical systems need to obtain suitable couplings for a particular mechanical or electromechanical system based on operating conditions and physical characteristics of that system. Thus, each time a new system is designed, it is typically necessary to design a new coupling for the application. In most circumstances, spacers, rigids, adapters and/or other coupling components must be designed for the specific application.

Presently, the process of configuring a coupling is complicated and time consuming. One or more individuals configuring the coupling are faced with various complex tasks that include identification of system characteristics and coupling operating conditions, selection of suitable coupling materials, part selection and/or design, validation and laborious Computer Aided Design (CAD) tool utilization.

### SUMMARY OF THE INVENTION

A system for designing a set of coupling components for coupling driving and driven shafts comprises an input module that provides a user interface for entering user input including one or more design parameters and/or user selections. A coupling selection and design module attempts to design at least one set of coupling components that meet the design parameters based on the user selections. An output module generates a coupling design specification file based on a selected one of the sets of coupling components from the coupling selection and design module.

In other features, a computer aided design (CAD) tool receives the coupling design specification file and that automatically generates detailed assembly drawings therefrom. When a plurality of sets of coupling components meet the design parameters, the coupling selection and design module prompts a user to select one of the sets of coupling components. When the coupling selection and design module fails to generate any sets of coupling components that meet the design parameters, the coupling selection and design module prompts the user to adjust at least one of the user selections and/or the design parameters. The coupling selection and design module designs the coupling components by specifying at least one of dimensions of the coupling components and/or coupling types that meet the design parameters. The coupling components include at least one of an adapter, a spacer and/or a rigid. The coupling components include off the shelf components including at least one of a nut, a bolt, a spacer and/or a shim.

In other features, a configuration options module performs selection of post design options based on user input. The post design options include at least one of an anti windage disc pack option, a desired stiffness option and/or a spacer material option. The output module generates the coupling design specification file based on the selection of one of the post design options. A manual design module performs manual modifications to one or more coupling components based on user input. The output module generates the coupling design specification file based on the manual modifications.

A method for designing a set of coupling components for coupling driving and driven shafts comprises providing a user interface for entering user input including one or more design parameters and/or user selections; attempting to design at least one set of coupling components that meet the design parameters based on the user selections; and generating a coupling design specification file based on a selected one of the sets of coupling components.

In other features, the method includes automatically generating detailed assembly drawings from the coupling design specification file. The method includes prompting a user to select one of a plurality of sets of coupling components that meet the design parameters. The method includes prompting the user to adjust at least one of the user selections and/or the design parameters when there are no sets of coupling components that meet the design parameters. The method includes designing the coupling components by specifying at least one of dimensions of the coupling components and/or coupling types that meet the design parameters. The coupling components include at least one of an adapter, a spacer and/or a rigid. The coupling components include off the shelf components including at least one of a nut, a bolt, a spacer and/or a shim. The method includes performing selection of post design options based on user input.

In other features the post design options include at least one of an anti-windage disc pack option, a desired stiffness option and/or a spacer material option. The output module generates the coupling design specification file based on the selection of one of the post design options. The method includes performing manual modifications to one or more coupling components based on user input. The method includes generating the coupling design specification file based on the manual modifications.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram illustrating a desk top embodiment of the coupling design system according to the present invention;

FIG. 2 is a block diagram illustrating a web-based embodiment of the coupling design system according to the present invention;

FIG. 3 is a block diagram illustrating a coupling design system according to the present invention;

FIG. 4 is a flow diagram illustrating a coupling design method according to the present invention;

FIGS. 5-32 are views of user interface components of the coupling design system according to the present invention;

FIG. 33 is an entity relationship diagram illustrating provision of user interface components to users in accordance with the present invention; and

FIGS. 34-40 are views of an exemplary CAD drawing generated in accordance with the present invention.

### DETAILED DESCRIPTION OF THE PREFERRED EMBODIMENTS

The following description of the preferred embodiments is merely exemplary in nature and is in no way intended to limit the invention, its application, or uses.

The coupling automation program according to some implementations of the present invention includes interfaces that gather relevant user inputs and design parameters of a coupling application, that generates one or more suitable coupling designs that meet the design parameters and that validates a selected coupling design. After completing validation, the coupling automation program generates a data file. The coupling automation program outputs the data file to a CAD program that automatically generates CAD coupling drawings based on the data file without requiring the services of a CAD technician. The coupling automation program creates the coupling design by designing at least one of an adapter, a rigid, a spacer and/or other coupling components and selecting other coupling components from off the shelf parts. Additional details of the coupling program are set forth below.

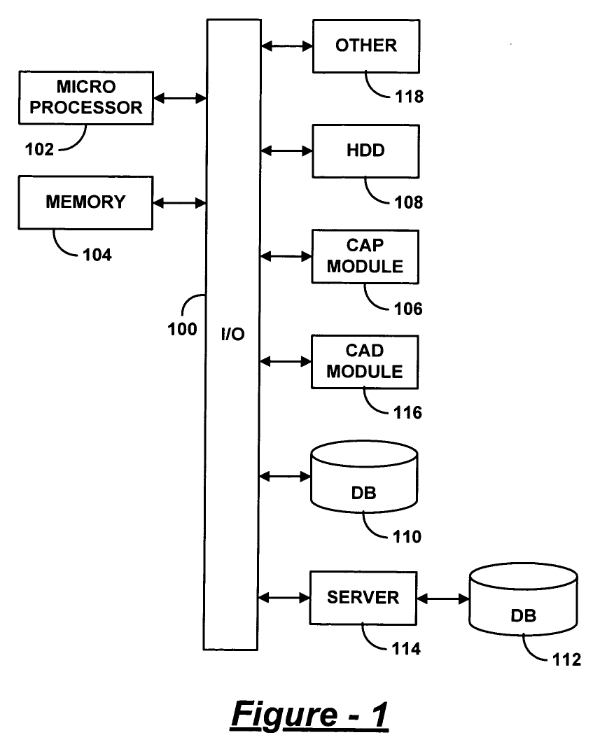

Referring to FIG. 1, a desk top embodiment of the coupling design system according to the present invention includes a microprocessor 102 having memory 104 and an input/output (I/O) interface 100. A coupling automation program 106 according to the present invention is executed by the microprocessor 102 and memory 104. The coupling automation module 106 interfaces with a database 108. The computer may include a hard disk drive 110 or other devices such as a floppy disk drive, CD/DVD drive, fire wire drive, USB memory device, etc. One or more input/output devices may also be provided such as a key board, mouse, printer, etc. The database 110 stores specifications of off the shelf parts, generic parameters of parts to be designed and/or other data that will be needed during the design process. Additional databases 112 may optionally be connected remotely via one or more servers 114. The coupling automation module 106 interfaces with a computer aided drafting (CAD) tool 116 as will be described below. It should be readily understood that an alternative, web-based embodiment of the coupling automation program and/or the computer aided design tool are remotely accessible over a distributed communications system.

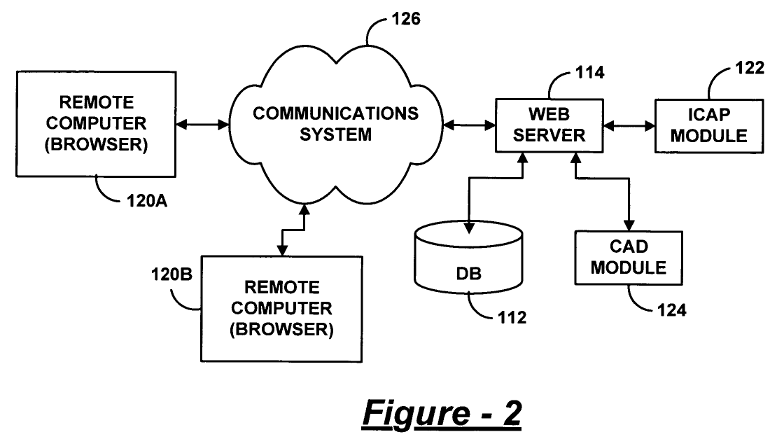

Turning now to FIG. 2, the web-based embodiment allows computers 120A and 120B to access the coupling automation program 122 and/or the computer aided design tool 124 via communications network 126. It should be readily understood that server 114 serves an applet, servlet, or similar application to remote computers 120A and 120B. Users access the coupling automation program via browsers running on their computers. The computers 120A and 120B need not have any local programs other than the browser. The distributed communications network can be the Internet, an intranet, and extranet, or any other transmission medium, wired or wireless, using Internet Protocol, narrowcast, broadcast, or any two-way communications technique. It should also be readily understood that the coupling automation program 122 and/or the computer aided design tool 124 access the database 112 during use.

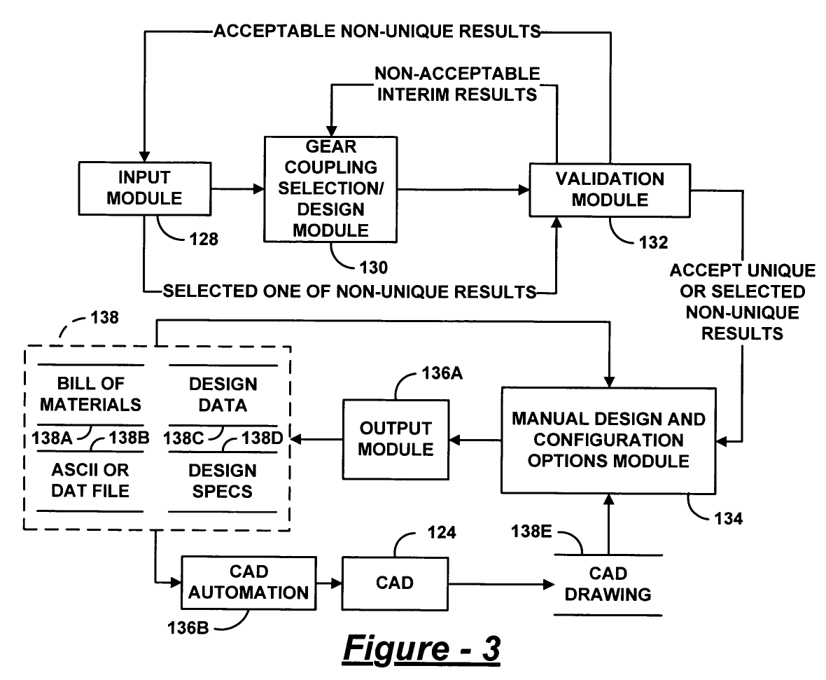

Turning now to FIG. 3, the coupling design system according to the present invention includes an input module 128 that generates user interface screens and that receives user input including one or more design parameters and/or user selections. A coupling selection and design module 130 provides user interface screens that allow selection of a coupling type, specification of shaft design parameters of driving and driven shafts, specification of a separation length of the driving and driven shafts, etc. as will be described further below. An output module 136A generates output 138 in one or more forms, including a coupling design specification file 138D.

In some embodiments, the coupling design system includes a validation module 132 that performs validation of the selected coupling design. The validation includes a determination of whether the selected parameters can meet performance specifications. If there are multiple configurations that will meet the performance specifications, the input module 128 prompts the user to select one If there are no acceptable results, the design is considered to be a non-acceptable interim result, and the user is afforded the opportunity to alter the design for a further validation attempt. Thus, the validation includes generation of validation results indicating whether a design is valid, and successful operation results in a validated design, whether unique or non-unique. Accordingly, the output module 136A generates the coupling design specification file 138D based the selected and validated design.

Additional or alternative embodiments further include a manual design modification and configuration options module 134. Module 134 allows the user to select options that can be added to the design, and/or to manually alter individual components of the design. Accordingly, the validated design can be supplemented and modified by user input selections and/or parameters. Where applicable, output module 136A generates the coupling design specification file 138D based on the options exercised and/or modifications made by the user to the design, so that the design specification file 138D reflects the modifications accordingly.

The design specification file 138D produced by the output module 136A is generated from active, current design data file 138C, which can alternatively or additionally be saved as its own file. Other outputs 138 that can be produced by output module 136A include a bill of materials 138A for all components of the designed coupling, and/or an ASCII or .DAT file 138B describing the designed coupling. In some embodiments, ASCII or .DAT file 138B serves as a user readable record of the specification file 138D. It can additionally or alternatively serve as a record of user defined data that references other files relating to the coupling design. The specification file 138D may be in purely machine readable form, and especially formatted for automated input to a computer aided design tool 124 via a CAD operator module 136B.

The CAD automation module 136B is software that feeds data from output 138 into tool 124 to produce a CAD drawing file 138E. It should be readily understood that CAD automation module 136B can be viewed as part of the output module 136A, and the CAD drawing file 138E thus produced can be viewed as part of the output 138. It should be readily understood that a single document can alternatively or additionally be created that takes the form of a CAD drawing 138E with one or more parts of the bill of material 138A, design data 138C, design specs 138D, and user supplied data of file 138B included in tables or other readouts of the drawing 138E.

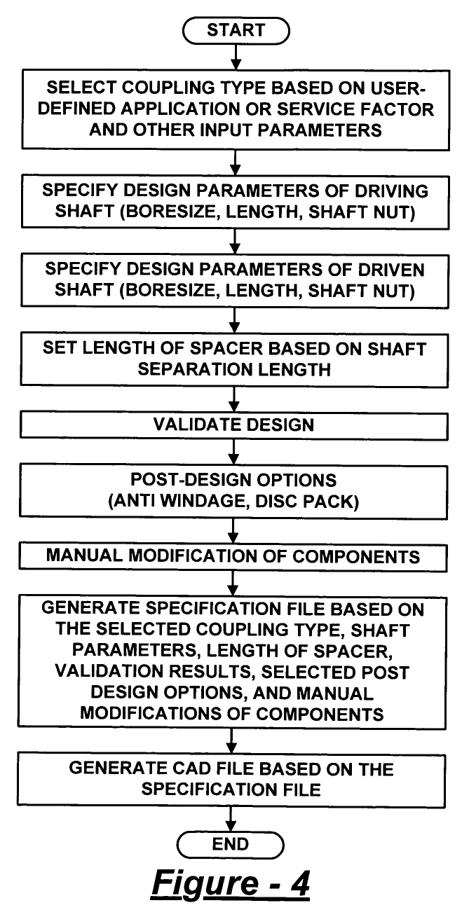

Turning now to FIG. 4, the coupling design method according to the present invention begins with performing a selection of a coupling type based on user input parameters at step 140. The coupling type can be selected based on a user-defined application. Alternatively or additionally, the coupling type can be selected based user input parameters that include a service factor. Other input data includes horsepower, speed, misalignment, and/or a ratio of lateral critical speed versus running speed. Still other input values will be apparent.

The method continues to steps 142 and 144, where the user is required to input or select parameters specifying shaft design parameters of driving and driven shafts. Example parameters include boresize, boretype length, and key details. Next, a length of a coupling spacer is set in step 146 based on a shaft separation length of the driving and driven shafts. At this point, enough design data has been collected to attempt to validate the design. If the design is not unique, then the corresponding designs are presented to the user for selection. If the design is unique, the user is allowed to alter the design or accept the design as a new, valid design.

The user is allowed to supplement or alter the valid design. For example, after a valid design has been obtained at step 148, the user is allowed to select one or more post design options at step 150. For example, the user is permitted to select an anti windage disc pack option, a desired stiffness option, and/or a spacer material option. The available selections of spacer material presented to the user can be constrained according to the desired stiffness. Also, the user is permitted to manually modify one or more components of the design at step 152 by setting new values for component characteristics. If desired, the ability to set new values for a component can be constrained according to component modifiability.

Once the user is satisfied with the coupling design, the user can generate a specification file in step 154 based on the data obtained in steps 140-152. The user can also generate a computer aided design (CAD) drawing type file based on the specification file at step 154, along with a bill of materials. Various file formats are provided for the user's convenience, and the CAD file and bill of materials can be delivered to the user over the Internet or other transmission medium. As a result, the user is able to obtain information for obtaining materials for creating the coupling along with a CAD file for doing so in a facilitated manner.

In a related system, the coupling design system is provided to users online. The system is adapted to constrain coupling component and materials selection to those provided by the manufacturer or capable of being manufactured on a custom basis.

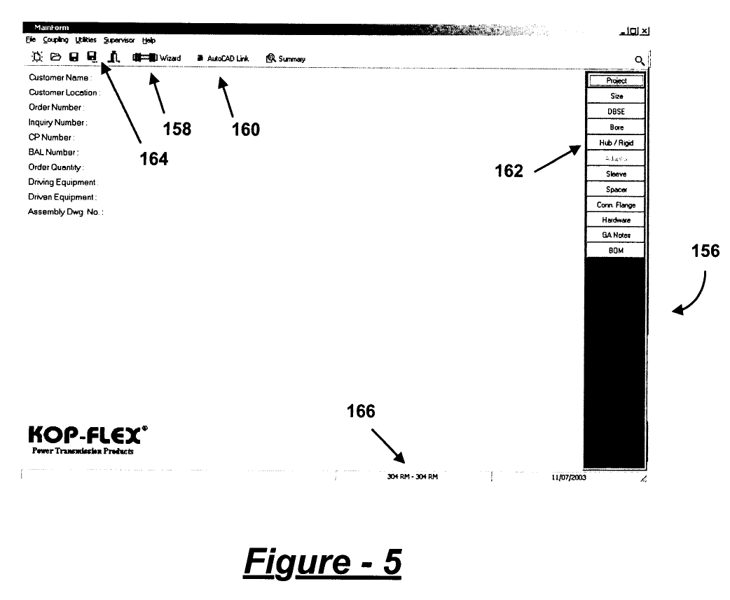

Turning now to FIGS. 5-33, components of a user interface according to some implementations of the present invention include various forms and controls for collecting user input in a facilitated fashion. The form in FIG. 5 is actively rendered when the user begins using the program, and serves as a central form 156 for accessing other forms, performing essential functions, and starting the coupling design process. For example, in a typical scenario, the user inputs data and selects a coupling, using a design wizard form accessed by command button 158. Also, the user saves C:/$Kop.dat, by clicking on ‘AutoCAD Link’ button 160. $Kop.dat is an intermediate file that is created by CAP application. This file will eventually be used to create the drawing in the AutoCAD. A dCAP lisp program is used to generate the drawing in the AutoCAD from the intermediate file. This program reads the $Kop.dat file and generates the drawing. Thus, if the user opens AutoCAD and types ‘dCAP’ command, a drawing selection dialog is opened. The user can select one drawing e.g. ‘General Assembly’ and click the OK button, in order to cause AutoCAD to generate the coupling drawing. Yet further, the user can change the active design using the modification menus 162 on the right hand side of the screen and repeat the drawing generation process. Useful calculator utilities 164 are additionally provided, plus a display component 166 of the active design size and style.

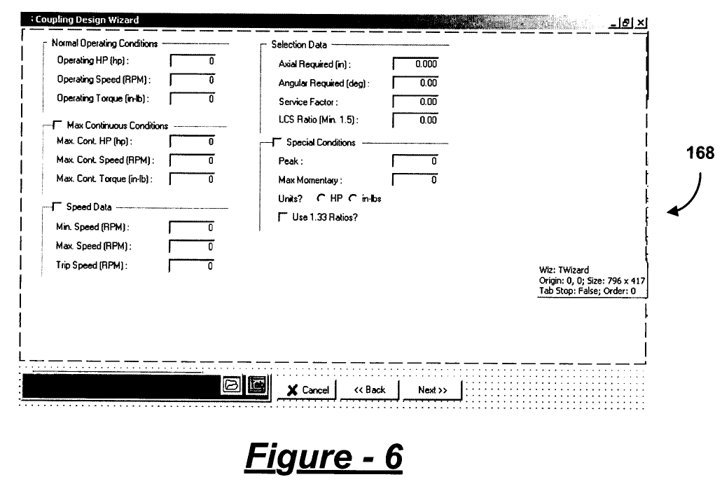

Turning now to FIG. 6, the design wizard form 168 includes categorized text boxes for collecting user input specifying various operating conditions. Accordingly, the user is queried to provide normal operating conditions, including horsepower, speed, and torque, maximum continuous operating conditions for these same values, speed data, axial misalignment data, and others as exemplified in Tables 1 and 2. Some fields may be mandatory and others optional, and validation values can be provided per certain input parameters.

TABLE 1

| NAME OF THE FIELD | VALUE | MAX | MIN |
|---|---|---|---|
| Operating HP (hp) | 10000 | 7 Digit | 1 |
| Operating Speed (RPM) | 6000 | 6 Digit | 1 |
| Operating Torque (in-lb) | Auto | 9 Digit | 1 |
| Max Continuous | Check Box | (next 3 selections | (if this box is |
| Conditions | | available only if | checked all |
| | | this check box is | values in the |
| | | “checked”) | frame need |
| | | | to be filled |
| | | | in) |
| Max Cont. HP (hp) | 12000 | 7 Digit | 1 |
| Max Cont. Speed (RPM) | 6200 | 6 Digit | 1 |
| Max Cont. Torque (in-lb) | Auto | 9 Digit | 1 |

TABLE 2

| | | | |
|---|---|---|---|
| SPEED DATA | CHECK BOX | (Next 3 selections | (if this box is |
| | | available only if | checked all values |
| | | this check box is “checked”) | in the frame need |
| | | | to be filled in) |
| Min Speed (RPM) | 5000 | 6 Digit | 1 |
| Max Speed (RPM) | 6200 | 6 Digit | 1 |
| Trip Speed (RPM) | 6700 | 6 Digit | 1 |
| Axial Required (in) | Auto and manual | 1 digit 3 decimals | 0 |
| Angular Required | Auto and manual | 1 digit 2 decimals | 0 |
| (deg) | | | |
| Service Factor | Auto and manual | 1 digit 2 decimals | 1 |
| LCS Ratio (Min. | Auto and manual | 1 digit 2 decimals | 1.5 For Cap and 2 |
| 1.5) | | | for ICAP |
| SPECIAL | CHECK BOX | This will | |
| CONDITIONS | | activate\deactivate | |
| | | everything below | |
| Peak | Auto-manual | | |
| Max Momentary | Auto-manual | | |
| Use 1.33 Ratios | Check Box | This will force selection to be | |
| | | 1.33 (Special conditions) | |

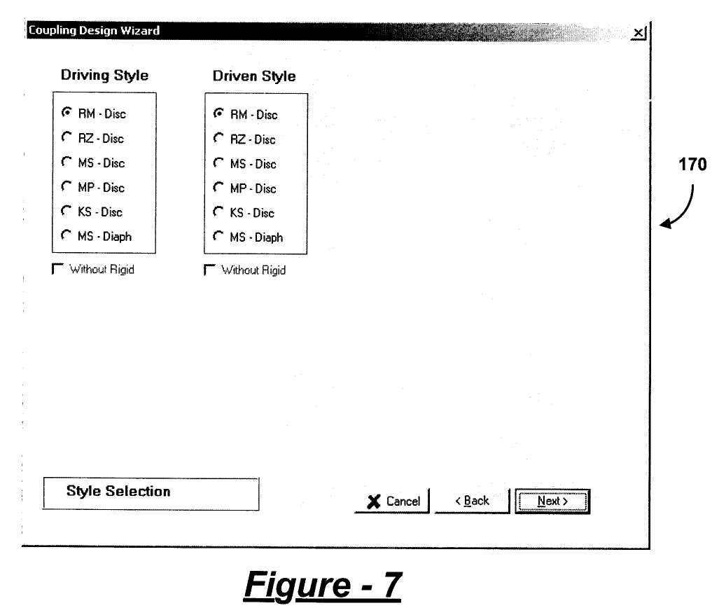

Form 168 collects the basic operating data. A special conditions section allows the user to enter any transient horsepower values that the coupling may see. Form 170 in FIG. 7 allows a user to specify a coupling style that can be used to select the type of coupling.

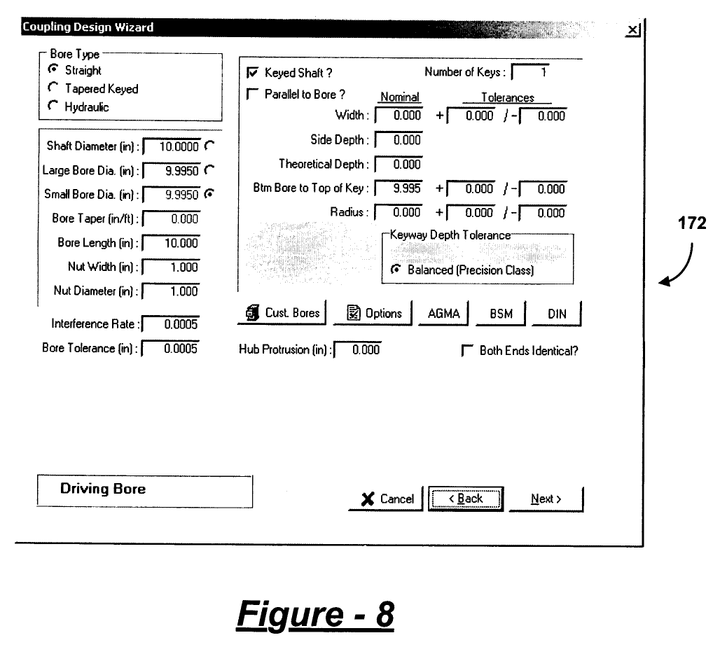

Turning now to FIG. 8, form 172 is used to enter information about the bore/shaft connection. Selecting values on this screen can help users design as per the database and specifications. Types of data communicated and/or collected by controls of form 172 are described in Table 3.

TABLE 3

| | | TAPERED | | | |
|---|---|---|---|---|---|
| NAME OF | STRAIGHT | KEYED | | | |
| THE FIELD | VALUE | VALUE | HYD VALUE | MAX | MIN |
| Shaft | Calculated | Calculated | Calculated | 2 digit 4 | 0.5 |
| Diameter | | | | decimal | |
| (in) | | | | | |
| Large Bore | 5 | 5 | 5 | 2 digit 4 | 0.5 |
| Dia. (in) | | | | decimal | |
| Small Bore | Disabled | Calculated | Calculated | 2 digit 4 | 0.5 |
| Dia. (in) | | | | decimal | |
| Bore Taper | Disabled | 0.5 | 0.5 | 1 digit 3 | 0.1 |
| (in/ft) | | | | decimals Max 2 | |
| Bore | 6 | 6 | 6 | 2 digit 3 | 0.5 |
| Length (in) | | | | decimals | |
| Nut Width | 0 | 0.75 | 0.75 | 1 digit 3 | 0 |
| (in) | | | | decimals | |
| Nut | 0 | 6 | 6 | 2 digit 3 | 0 |
| Diameter | | | | decimals | |
| (in) | | | | | |

| | | | |
|---|---|---|---|
| | If any one of width and diameter is | | |
| | non zero, other will also be non zero | | |
| Interference | Auto, manual | 0.0035 CAP | 0.0001 |
| Rate | | 0.003 ICAP | |
| Bore | Def, manual | 0.02 | 0.0001 |
| Tolerance | | | |
| (in) | | | |
| Parallel to | Check Box | | |
| bore | | | |
| Keyed shaft | Check Box (all below available if this | | |
| | is checked) | | |
| Number of | 1 | 2 | 1 |
| Keys | | | |
| Width | 1.25 | 1 Digit 3 | 0.1 |
| (Nominal) | | decimals | |
| Tolerance+ | 0.004 | 1 Digit 3 | 0 |
| | One tolerances must be non-zero | decimals | |
| | | 0, 1 Max | |
| Tolerance− | 0 | 1 Digit 3 | 0 |
| | | decimals | |
| | | 0, 1 Max | |
| Side Depth | 0.625 | 1 Digit 3 | 0.1 |
| | | decimals | |
| Theoretical | 0.546 | 1 Digit 3 | 0.1 |
| Depth | | decimals | |
| Btm Bore to | 5.546 | 1 Digit 3 | 0.6 |
| Top of key | | decimals | |
| Tolerance+ | 0.005 | 1 Digit 3 | 0 |
| | One of tolerances has to be some | decimals 0, 1 | |
| | value | Max | |
| Tolerance− | 0 | 1 Digit 3 | 0 |
| | | decimals 0, 1 | |
| | | Max | |
| Radius | 0.12 | 1 Digit 3 | 0.01 |
| | | decimals | |
| Tolerance+ | 0.02 | 1 Digit 3 | 0 |
| | One of tolerances has to be some | decimals 0, 1 | |
| | value | Max | |
| Tolerance− | 0 | 1 Digit 3 | 0 |
| | | decimals 0, 1 | |
| | | Max | |
| AGMA | Radio group | | |
| Options | | | |
| Interference | Radio | | |
| fit | | | |
| Clearance | Radio | | |
| fit | | | |
| Keyway | Radio group | | |
| depth | | | |
| tolerance | | | |
| Non | | | |
| Balanced | | | |
| Balanced | | | |
| Hub | 0 | 1 Digit 3 | 0 |
| Protrusion | | decimlas | |
| (in) | | | |
| Both ends | Check Box | | |
| identical | | | |
| AGMA | PushButton | | |
| BSM | PushButton | | |
| DIN | PushButton | | |
| Options | PushButton (This will popup new | | |
| | screen.) | | |
| Cust. Bores | PushButton (This will popup new | | |
| | screen.) | | |

An apply button can be provided that transfers values to a main screen deleting the previous screen. Side depth, theoretical depth, and bottom of bore to top of key dimensions describe the same measurement. Bottom of bore to top of key is the only dimension that appear on a drawing, so it is the only one with a tolerance. The user can fill in any of the three values and automatically cause the other two to be recalculated.

Radio buttons can be labeled “Shaft Diameter”, “Large Bore Dia.”, and “Small Bore Dia.” and used to designate a factor that remains constant when the other two values are recalculated. Shaft diameter is related to large bore diameter by the interference rate. Large bore and small bore are related to each other by taper rate and bore length. For example, if a large bore radio button is selected and the interference rate is changed, the shaft diameter can be recalculated.

A small bore diameter radio button may not be provided in some embodiments, but rather provided as a label that communicates a small bore parameter that is automatically calculated based on other information. A check box control can also be provided that allows the user to indicate whether both ends are identical. If so, the driving bore data can be copied for the driven bore. In this case, the driven bore screen is automatically skipped for the user.

AGMA standard is the default selection, but command button controls allow the user to toggle between AGMA, BSM and DIN standards. This ability, however, is only available with the keyed shaft option. In general, if the user deselects a check box indicating whether the keyed shaft option is exercised, and if previous screen values are there, they remain as they are. It should be noted that keyed shaft area values can be entered manually. However, AGMA, BSM and DIN standards are based on the large bore diameter values. If the user changes this value, the standard AGMA, DIN, etc. changes the way it calculates. Accordingly, manually keyed entry may be disallowed with these standards.

Bore type selection constrains other selections. For example, a straight bore type selection can be keyed or non-keyed. However, a tapered keyed selection always has a key. In contrast, a hydraulic type selection does not allow a keyed shaft option. Also, the interference rate changes as per the bore type selection. In some embodiments, the interference rate can be tied to a particular bore specification.

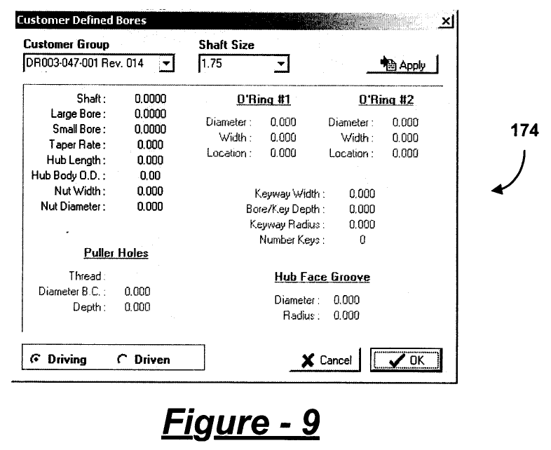

In addition to labeled text fields permitting user entry of specific data categories detailed in Table 3, such as bore diameters, taper lengths, nut widths and diameters, etc., additional or alternative controls can be provided, some of which may also be detailed in Table 3. For example, a labeled text field can permit user entry of hub protrusion data. Hub protrusion, though rarely used, can be employed in an attempt to control an amount of hub overhang over a shaft end. Also, a customer bore command button can also be provided to pick up values from a database. Further, an options button allows specification of a customer group for different bore specifications utilizing form 174 of FIG. 9. Types of data communicated and/or collected by controls of form 174 are detailed in Table 4.

TABLE 4

| | | | |
|---|---|---|---|
| NAME OF THE FIELD | VALUE | MAX | MIN |

| | |
|---|---|
| Customer group | List Box - built from |
| | CustName table in dbase |
| Shaft Size | List Box - built from |
| | CustBores table in dbase |
| Apply | Push Button |

After the user pushes an apply button, the values selected in form 174 are transferred to the previous screen, form 172. An OK button also permits return to the previous screen, but without changing any values in form 172. Other static values on screen can be populated as per the selection, and all the values collected in form 174 can be used to apply specific customer bore specs to the active design. It is envisioned additional or alternative embodiments can collect data for o-ring tolerances, int rate, break edges, and standard non-cap groove lengths for addition to the bore specs.

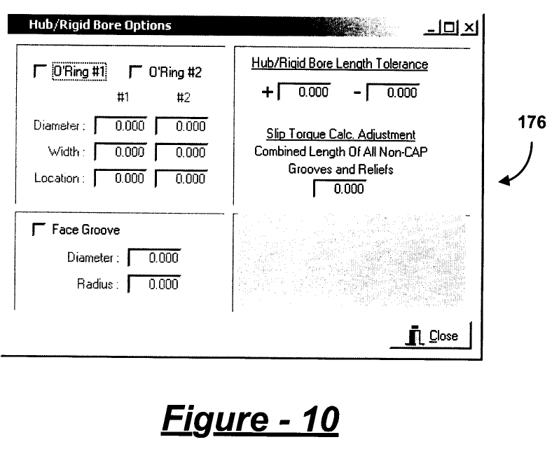

Turning to FIG. 10, data for various bore options can be collected via form 176. The types of data collected by controls of form 176 are detailed in Table 5.

TABLE 5

| NAME OF | | | | |
|---|---|---|---|---|
| THE FIELD | VALUE | | MAX | MIN |
| O Ring #1 | Check Box | | | |
| | Enables 3 below | | | |
| O Ring #2 | Check Box | | | |
| | Enables 3 below | | | |
| | #1 | #2 | | |
| Diameter | 5.205 | 5.205 | 2 Digits 3 | >Bore |
| | | | decimals, max = body | |
| | | | diameter − 0.5 | |
| Width | 0.233 | 0.233 | 1 Digits 3 | 0.05 |
| | | | decimals | |
| Location | 0.313 | 0.313 | 1 Digits 3 | 0.10 |
| | | | decimals | |

| | | | |
|---|---|---|---|
| Face Group | Check Box | | |
| | Enables 2 below | | |
| Diameter | 5.130 | 2 Digit 3 decimals, | >Bore + |
| | | max = (body | 0.12 |
| | | diameter + large | |
| | | bore)/2 | |
| Radius | 0.060 | 1 Digit 3 decimals | 0.02 |
| Bore length | | | |
| tolerance (Both | | | |
| can be 0) | | | |
| “+” | 0.005 | 1 digit 3 decimals | 0 |
| “−” | 0.005 | 1 digit 3 decimals | 0 |
| Slip torque calc. | 0.375 | 1 digit 3 decimals | 0 |
| adj | | | |
| Shaft diameter | | | |
| Large bore | | | |
| diameter | | | |
| Interference rate | | | |

Form 176 allows the user to enter custom information about the bore and shaft connection. In particular, O-Ring #1 is at the large end of bore, while O-Ring #2 is at the small end of the bore. Also, Diameter is the O-ring groove OD, while Width is the O-ring groove width and Location is the distance from the closest hub face. Further, Face Groove is designed to be full radius. Finally, Diameter is the ID of the groove, while radius is the depth and width.

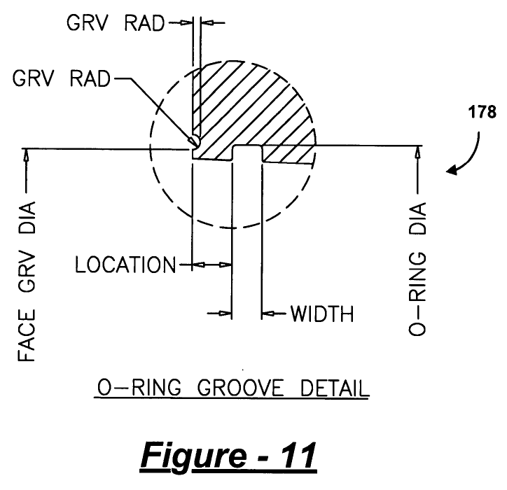

Bore length tolerance shows up on the GA. Slip torque adjustments are applied to the bore length for the slip torque calculation in order to reduce it in accordance with API 671 3^{rd} Edition Fit Length Adjustment For Slip Torque Calculation, by removing grooves, reliefs, chamfers, and hydraulic ports. A “Close” button can apply changes to an active design. It is envisioned in additional or alternative embodiments that a “Large End” label can be used for O-Ring #1, a “Small End” label can be used for O-Ring #2, and that a “Slip Torque . . . ” label can be replaced with a label for “API 671 3^{rd} Edition Fit Length Adjustment For Slip Torque Calculation”. Referring to FIG. 11 is also envisioned that a sketch 178 can be added to the form 176 (FIG. 10) in order to show the breakout point for the face groove diameter as well as O-Ring groove information.

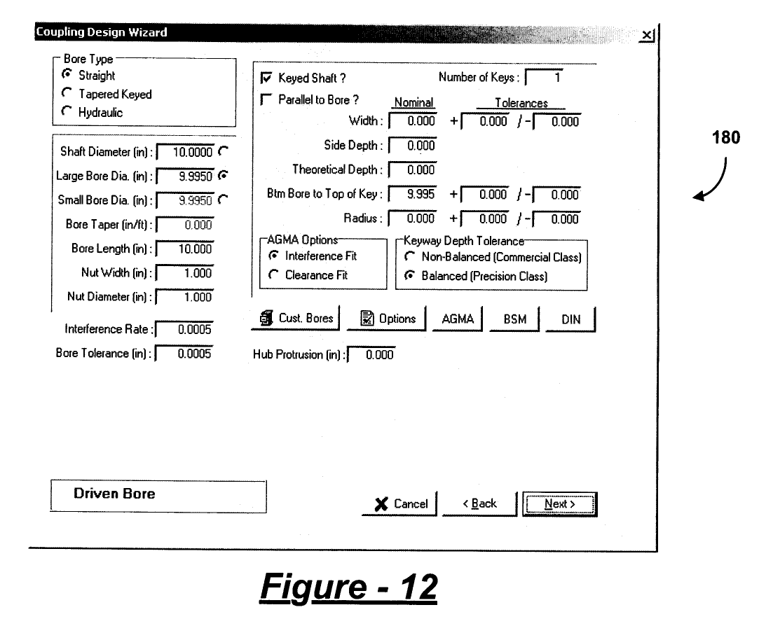

Turning to FIG. 12, form 180 collects data for the driven bore in the case that the user did not indicate that both ends were identical when interfacing with form 172 of FIG. 8. Other than a removal of a checkbox for specifying whether both ends are identical, controls of form 180 (FIG. 12) collect the same information for the driven bore as controls of form 172 collect for the driving bore. Likewise, forms 172 (FIG. 9) and 174 (FIG. 10) are similarly accessible from form 180 (FIG. 12), and collect data for application to the driven bore instead of the driving bore when accessed from form 180.

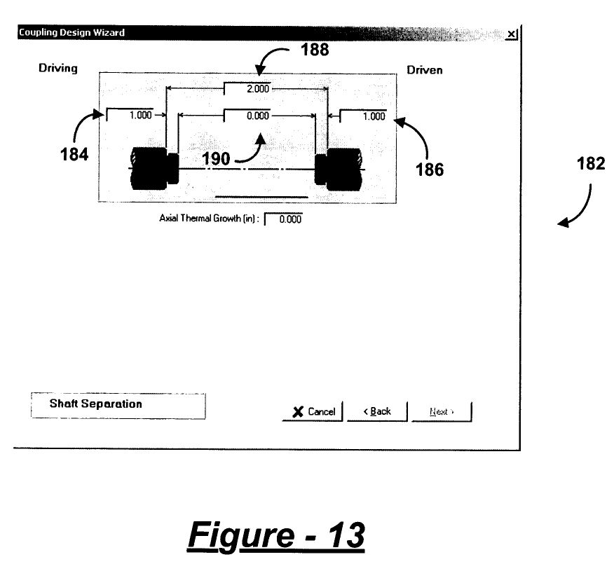

Turning to FIG. 13, form 182 permits the user to specify the shaft separation. Types of data communicated and/or collected by controls of form 182 are detailed in Table 6.

TABLE 6

| NAME OF THE FIELD | VALUE | MAX | MIN |
|---|---|---|---|
| (Left to right) | | | |
| A = user should not fill up | 0.75 | 1 digit 3 decimals | 0 |
| (label). Display from | | | |
| previous screen | | | |
| B | Auto - Manual | 3 digit 3 decimals | 3 |
| C | 18 - Manual | 3 digit 3 decimals | 3 |
| D = user should not fill up | 0.75 | 1 digit 3 decimals | 0 |
| (label). Display from | | | |
| previous screen | | | |
| Axial thermal growth | 0.075 | 1 digit 3 decimals | 0 |

A picture of separated bores with meaningfully located text entry fields is provided for user reference, but the picture is not updated for different configurations (integral flange, not shaft nut, etc.). However, it is envisioned that additional or alternative embodiments may update the picture for the user according to the information supplied by the user in forms 168-180 (FIGS. 6-12).

Via form 182 (FIG. 13), the user enters the shaft separation and thermal growth parameters. It is envisioned that additional or alternative embodiments can have labels at 184 and 186 instead of text entry fields, while text entry filed 188 and 190 allow the user to specify the shaft separation parameters. Also, if a value of (“Axial Thermal Growth”)/2> “Axial Required (in)” collected by form 168 (FIG. 6), then the Axial Thermal Growth (ATG) value can be used to replace the Axial Required (AR) value for selection purposes. Accordingly, service factor parameters relating to axial misalignment are intelligently obtained from the user.

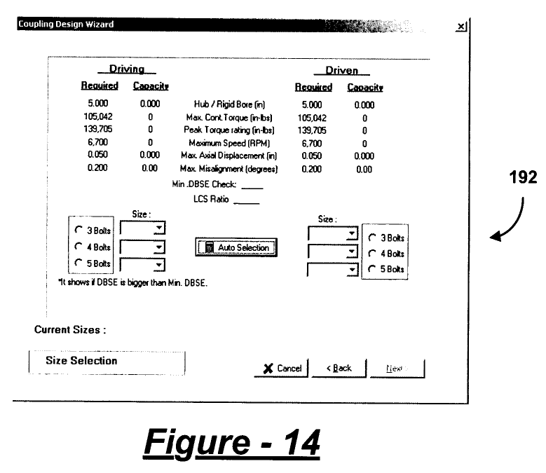

Turning to FIG. 14, form 192 presents validation data to the user. Accordingly, CAP selects a coupling size based on user inputs when an Auto Selection button is pressed. This selection is based on limits and constraints included in the CAP code. If there is a valid selection CAP chooses a 3, 4, and 5 bolt coupling size. The user then has the option to pick from those three choices; but the user can also select another size from a list box that can override the CAP selection. It is envisioned that additional or alternative embodiments can allow for automatic selection of larger bolt sizes. However, in a presently preferred embodiment, radio buttons for all discs are 3, 4 and 5 bolts, but additional or alternative embodiments may not show the 3, 4, and 5 bolts for diaphragm, but for M, H, and X profile.

Various embodiments can have various types of form intelligence, which can be combined or used separately. For example, form intelligence can provide that if a required value > a capacity value, then the capacity value should be shown in red or with another display property that indicates satisfaction of the condition to the user. Also, form intelligence can provide that if DBSE>0.80*min dbse value, then a next button should be available. Further, form intelligence can provide that if a ratio of lateral critical speed versus running speed (LCS ratio)<required LCS ratio, then a next button is not available. Yet further, form intelligence can provide that if LCS ratio<required LCS ratio, then an option can be offered the user to “fix it” (probably by upsizing).

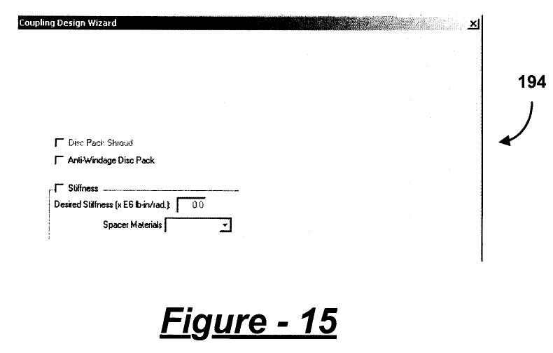

Turning to FIG. 15, form 194 allows the user to select options. Types of data communicated and/or collected by form 194 are detailed in Table 7.

TABLE 7

| NAME OF | | | |
|---|---|---|---|
| THE FIELD | VALUE | MAX | MIN |
| Disc pack shroud | | | |
| Anti Windage | | | |
| disc pack | | | |
| Stiffness | Checkbox - | | |
| | activates two | | |
| | below | | |
| Desired Stiffness | Auto/manual | 3 digits 1 decimal - | Manual - |
| (x E6 lb-in/rad) | | with a calculated | but with |
| | | absolute max | a calculated |
| | | | absolute min |
| Spacer material | List Box | | |

An option to select an Anti-Windage Disc pack can be made available only with RM. Similarly, an option to select a Disc pack Shroud can be made available only with RZ. In some embodiments, a checkbox for selecting to provide stiffness criteria may be labeled “Spacer Tuning” instead of “Stiffness”. Similarly, a label for a text entry field control may be “Desired Stiffness” or “Desired Coupling Stiffness”.

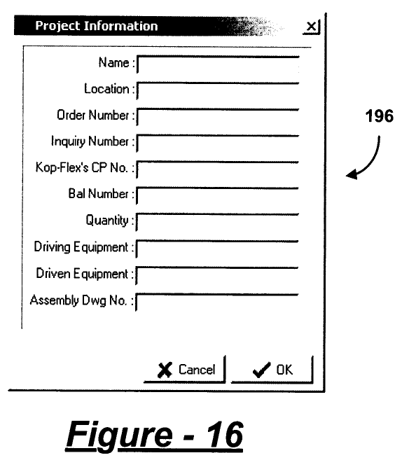

Turning to FIG. 16, form 196 allows the user to create a .DAT file of the current design for subsequent modification. Form 196 allows the user to enter customer information for ID numbers for this coupling design. This form 196 can also be accessed by clicking on the text at the left side of the main form 168 (FIG. 5). Form 196 (FIG. 16) collects and saves information such as name, location, order number, inquiry number, part numbers, quantities, driving and driven equipment types, and an assembly drawing number into a .DAT file. This information is fed into an ACAD design. Later, customer description and other information may be added.

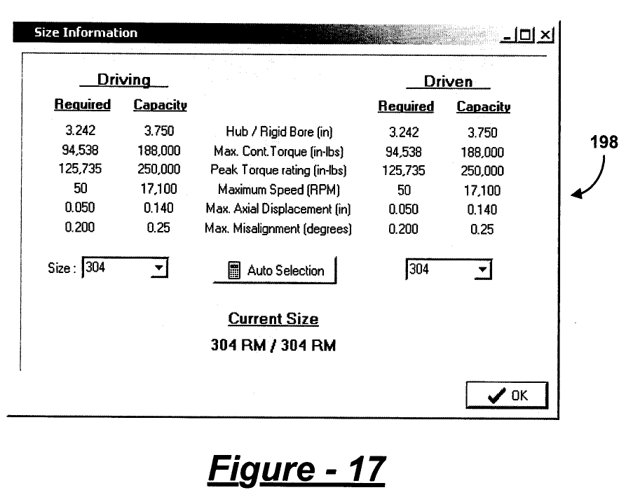

Turning to FIG. 17, form 198 allows the user to modify size information for coupling components in the current coupling design. Types of data communicated and/or collected by controls of form 198 are detailed in Table 8.

TABLE 8

| | | | |
|---|---|---|---|
| FIELD | VALUE | MAX | MIN |

| | |
|---|---|
| Driving Size | List box |
| Driven Size | Listbox |

Form 198 is used to change the coupling size after the expertly directed, automated portion of the configuration has been completed. It is envisioned that form 198 in additional or alternative embodiments can have a format similar to form 192 (FIG. 14) with controls permitting 3, 4, and 5 bolt options.

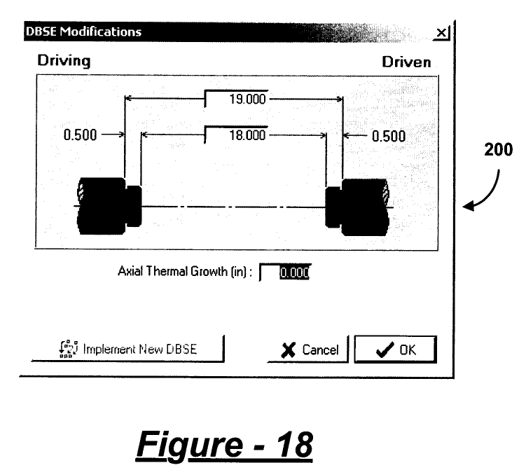

Turning to FIG. 18, form 200 permits the user to modify the DBSE after the automated, expertly driven configuration is completed. Types of data communicated and/or collected by controls of form 200 are detailed in Table 9.

TABLE 9

| NAME OF THE FIELD | VALUE | MAX | MIN |
|---|---|---|---|
| A | Auto - Manual | 3 digit 3 decimals | 3 |
| B | Auto - Manual | 3 digit 3 decimals | 3 |
| Axial thermal | Auto - Manual | 1 digit 3 decimals | 0 |
| growth | | | |

A command button entitled “Implement New DBSE” can allow the user to apply specified changes to the active design.

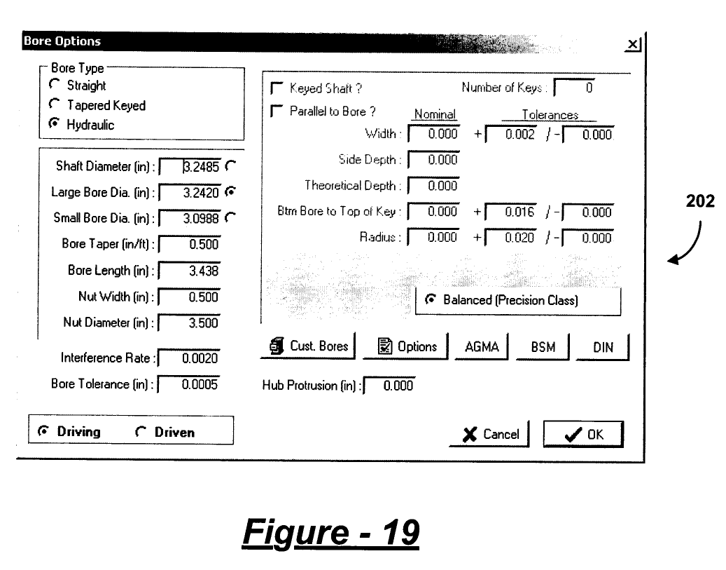

Turning to FIG. 19, form 202 allows the user to modify parameters of the driving or driven bores. Accordingly, form 202 is similar to forms 172 (FIG. 8) and 180 (FIG. 12) in form and function, with radio buttons allowing the user to specify whether changes are to be applied to the driving or the driven bore, and whether other forms accessible from form 202 that apply other changes will necessarily apply the changes to the driving or driven bores.

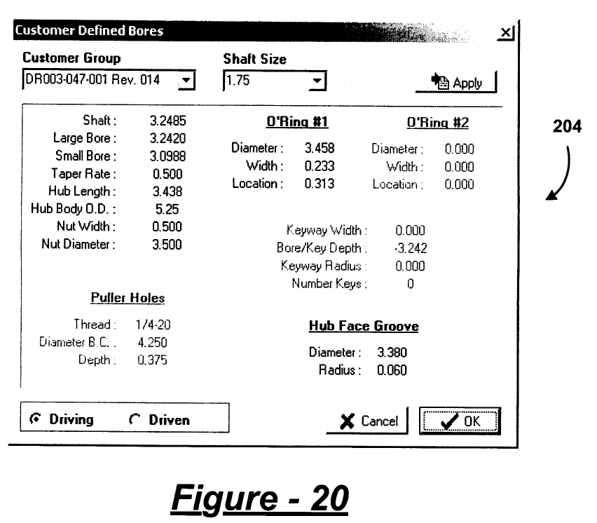

Turning to FIG. 20, form 204 allows the user to change the customer bore parameters, and is similar in form and function to form 174 (FIG. 9).

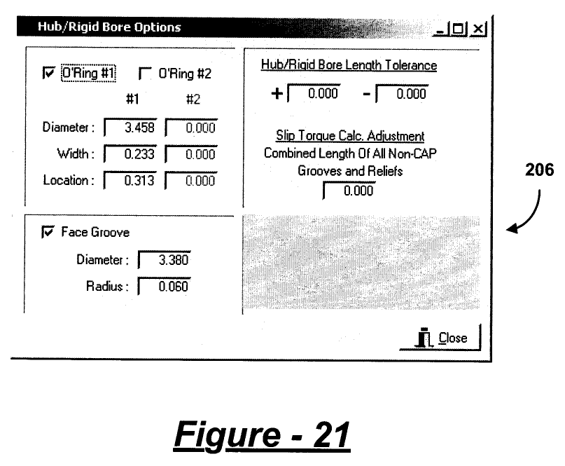

Turning to FIG. 21, form 206 allows the user to change the bore options that were previously specified using form 176 (FIG. 10). Form 206 (FIG. 21) is similar in form and function to form 176. (FIG. 10).

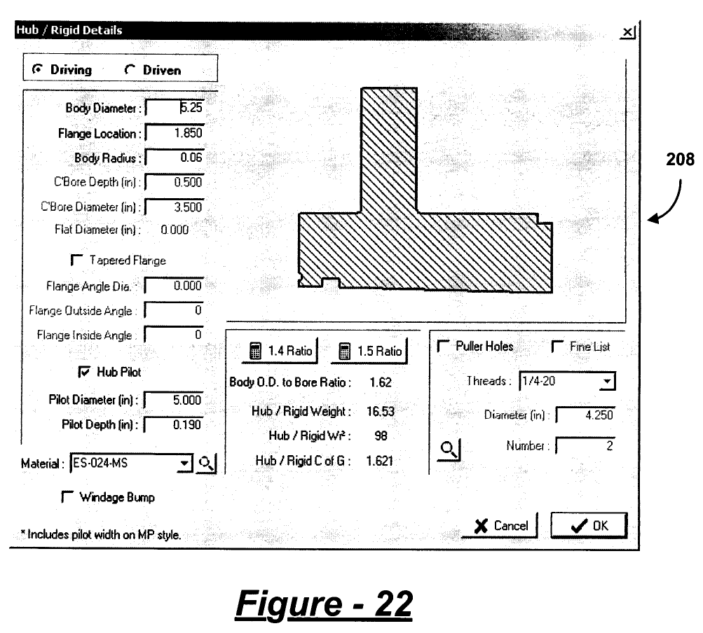

Turning to FIG. 22, form 208 allows the user to make custom modifications to the hub/rigid. Types of data communicated and/or collected by controls of form 208 are detailed in Table 10.

TABLE 10

| FIELD | VALUE | | | | MAX | MIN |
|---|---|---|---|---|---|---|
| | RZ-RM | | MP-MS | | | |
| Body | 5.25 | | 7.5 | | 2 digit 2 | 1.1 |
| diameter | | | | | decimals | times |
| | | | | | | bore |
| | | | | | | size |
| Flange | 1.85 | | Disabled | | 1 Digit 3 | 0 |
| location | | | | | decimals | |
| Body radius | 0.06 | | 0.25 | | 1 Digit 2 | Non |
| | | | | | decimals | zero |
| Cbore depth | Always disabled | | Always disabled | | | |
| Cbore | Always disabled | | 9.75, auto-no | | 2 digit 3 | 1.1 |
| diameter | | | manual | | decimals | times |
| | | | | | | bore |
| | | | | | | size |
| Tapered | Check Box | | (Only available | | When | |
| Flange | Disabled | | when nut width and | | deactivated | |
| | nut dia are 0 and | | | | turns off the | |
| | the default is ON) | | | | next three | |
| | | | Tapered | Stepped | | |
| | RZ-RM | No Nut | Flange | Flange | | |
| Flange | Disabled | 10.28 | 8.94 | Disabled | 2 digits 3 | >Body |
| Angle Dia | | | | | decimals, | dia * 1.10 |
| | | | | | max = H_PDIA | |
| | | | | | from | |
| | | | | | database | |
| Flange | Disabled | 75 | 60 | Disabled | 2 digits, max = 85 | 0 |
| outside | | | | | | |
| angle | | | | | | |
| Flange | Disabled | Disabled | 65 | Disabled | 2 digits, max = 85 | 0 |
| inside angle | | | | | | |

| | | | | |
|---|---|---|---|---|
| | RZ-RM | MP-MS | | |
| Hub pilot | Check Box | Disabled | | |
| | (Activates 2 | | | |
| | below) | | | |
| Pilot dia | Auto, manual, 5 | Disabled | 2 digits 3 | <Body |
| | | | decimals, | dia |
| | | | max = body | |
| | | | dia | |
| Pilot depth | Auto, manual, | Disabled | 1 digit 3 | 0 |
| | 0.19 | | decimals, | |
| | | | max = 0.9* | |
| | | | flange | |
| | | | location | |

| | | | |
|---|---|---|---|
| Material | List box **See note below | | |
| Windage | Check box - Except RM disabled for | | |
| Bump | everything | | |
| Windage | Check box - Everyplace it should be | | |
| shroud | disabled | | |
| 1.4 ratio | Push button changes body/bore ratio | | |
| 1.5 ration | Push button changes body/bore ratio | | |
| Puller holes | Check box Enables fields below | | |
| Fine list | Check box - Modifies the threads list | | |
| | box | | |
| Threads | List Box - Database | | |
| Diameter | 6.25 | 2 digits 3 | >Bore + 1.5 |
| | | decimals, | times |
| | | max = Body | thread dia |
| | | OD − 1.5* | |
| | | thread dia | |
| Number | 2 | 4 (not 3) | 2 |
| Magnifier | Push button - Displays another window | | |

Form intelligence can allow the user to double click on a puller hole diameter control and thereby set the diameter equal to: (Body OD+Bore)/2. It is also envisioned that various embodiments can have a label, rather than a text entry field for a “C′ Bore Diameter” parameter. It is envisioned that all material listboxes in CAP can have their available options limited based on the form and the part that is being modified. This functionality can apply to every from having a material listbox, with specific limits set for each form.

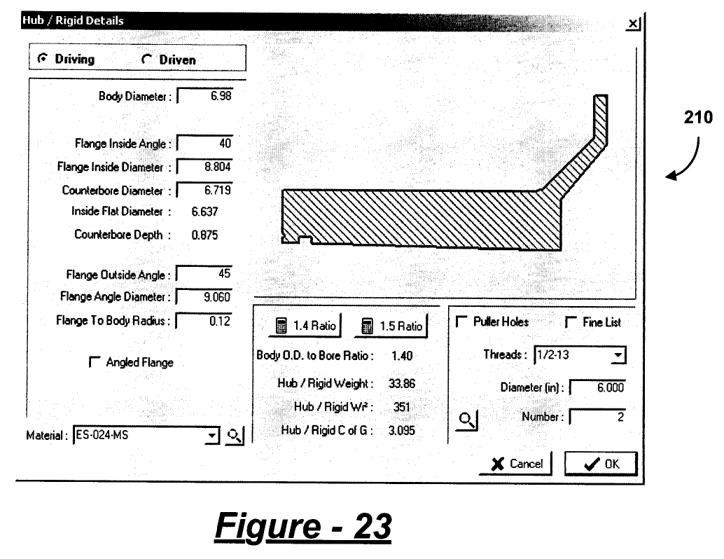

Turning to FIG. 23, form 210 allows the user to modify another type of HUB/Rigid. Types of data communicated and/or collected by controls of form 210 are detailed in Table 11.

TABLE 11

| FIELD | VALUE | | | MAX | MIN |
|---|---|---|---|---|---|
| Body diameter | 6.98 | | | 2 digit 2 | 1.1 times bore |
| | | | | decimals | size |
| | | Tapered | Stepped | | |
| | No Nut | Flange | flange | | |
| Flange Inside | Disabled | 40 | | 2 digits | non-zero |
| Angle | | | | | |
| Flange Inside | Disabled | 8.804 | | 2 digits 3 | body diameter |
| Diameter | | | | decimals | |
| | | | | Flange | |
| | | | | Angle | |
| | | | | Diameter - | |
| | | | | 2 * H_FWD | |
| Counterbore | 7.000 | 6.719 | 7.028 | 2 digit 3 | 1.1 times bore |
| diameter | | | | decimals | size |
| Flange Outside | 75 | 45 | | 2 digits | non-zero |
| Angle | | | | | |
| Flange Angle | 9.130 | 9.060 | | 2 digit 3 | body diameter |
| Diameter | | | | decimals | |
| | | | | H_FOD- | |
| | | | | 2 * H_FLAT- | |
| | | | | 0.12 | |
| Flange To | .25 | .12 | .12 | 1 digit 2 | non-zero |
| Body Radius | | | | decimals | |

| | | | |
|---|---|---|---|
| 1.4 ratio | Push button - changes body/bore | | |
| | ratio | | |
| 1.5 ratio | Push button - changers body/bore | | |
| | ratio | | |
| Puller holes | Check box Enables fields below | | |
| Fine list | Check box - Modifies the threads | | |
| | list box | | |
| Threads | List Box - Database | | |
| Diameter | 6.000 | 2 digits 3 | >Broe + 1.5 |
| | | decimals, | times thread |
| | | max = Body | dia |
| | | OD − 1.5* | |
| | | thread | |
| | | dia | |
| Number | 2 | 4 (not 3) | 2 |
| Puller Magnifier | Push button - Displays puller hole | | |
| | calculation window | | |
| Angled Flange | Checkbox | | |
| Material | List box **See note below | | |
| Material | Push button - Displays material | | |
| Magnifier | list window | | |
| Angled Flange | Checkbox | | |

Form 210 allows the user to make custom modifications to a diaphragm hub/rigid. The form and function of form 210 is similar to that of form 208 (FIG. 22), but the initial values presented to the user for modification are different, and an illustration of the component being modified is different. In some embodiments, these illustrations can change during modification to reflect the modifications. In others, the illustrations remain fixed during modification, and merely communicate the type of component being modified.

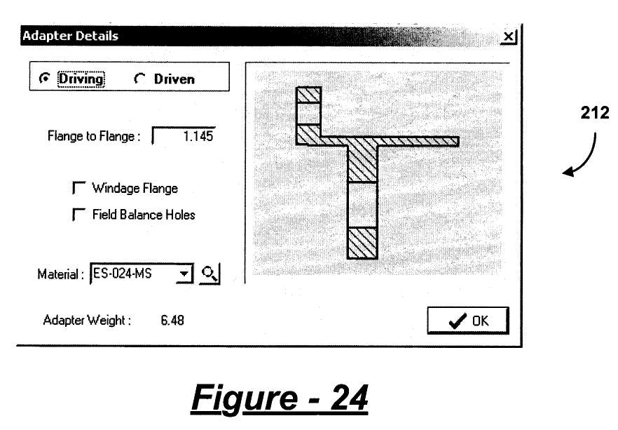

Turning to FIG. 24, form 212 allows the user to make a set of simple modifications to a standard adapter. Types of data collected by controls of form 212 are detailed in Table 12.

TABLE 12

| FIELD | VALUE | MAX | MIN |
|---|---|---|---|
| Flange to flange | Auto, manual | 2 digits 3 | >cfwd + A_fwd |
| | | decimals | (Refer code) |
| Windage flange | Check Box - | | |
| | disable | | |
| Field balance | Check Box | | |
| holes | | | |
| Material | List box | | |

If there are no changes made, the standard adapter part numbers are used in the Bill of Material (BOM). Driving and driven radio buttons can allow the user to switch back and forth. Some embodiments may not have a “Windage Flange” checkbox. Additional or alternative embodiments can show adapter weight+h′ware weight+½ disc pack weight on the form as well as the “adapter weight”.

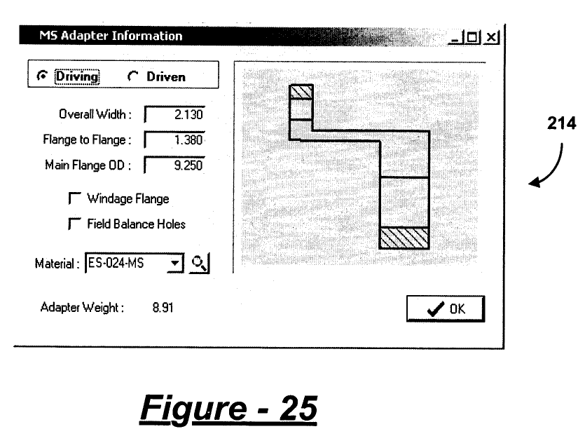

Turning to FIG. 25, form 214 allows the user to modify another type of standard adapter that may be part of a current design. Types of data collected by controls of form 214 are detailed in Table 13.

TABLE 13

| FIELD | VALUE | MAX | MIN |
|---|---|---|---|
| Overall Width | Auto, manual (tied | 2 digits | >cfwd + A_fwd |
| | to flange to flange) | 3 decimals | (Refer code) |
| Flange to flange | Auto, manual | 2 digits | >nominal − |
| | | 3 decimals | A_fwd/2 |
| Main Flange OD | Auto, manual | 2 digits | >A_CFID + .25 |
| | | 3 decimals | |
| Windage flange | Check Box - | | |
| | disable | | |
| Field balance | Check Box | | |
| holes | | | |
| Material | List box | | |

Form and function of form 214 is similar to that of form 212 (FIG. 24), but the initial values and an illustration provided to the user are different. Additional or alternative embodiments are similarly correspondent, while illustrations provided to the user may or may not adjust to reflect modifications, depending on the embodiment.

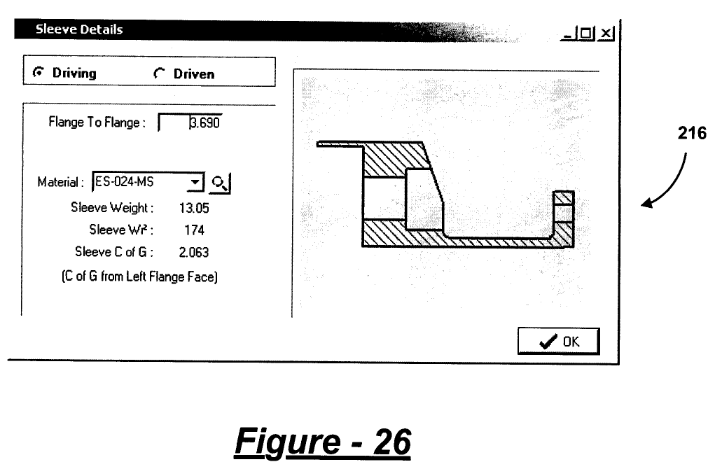

Turning to FIG. 26, form 216 allows the user to modify a standard sleeve. Types of data collected by form 216 are detailed in Table 14.

TABLE 14

| FIELD | VALUE | MAX | MIN |
|---|---|---|---|
| Flange to | Auto (L_LEN−L_SWD) | 2 digits 3 | >90% Auto value |
| flange | | decimals | |
| Material | List box | | |

If there are no changes made on this page, the standard sleeve part numbers are used in the BOM. The driving and driven radio buttons allow the user to switch back and forth. Additional or alternative embodiments can also show sleeve weight+h'ware weight+½ disc pack weight on the form as well as the “sleeve weight”. Various embodiments can further show cg or (sleeve+h′ware+½ disc pack) on the form as well as the “sleeve cg”, with form intelligence calculating the sleeve center of gravity (cg). An illustration can communicate the dimensions of the standard sleeve to the user, with the dimensions visually communicated corresponding to those either before or after modification.

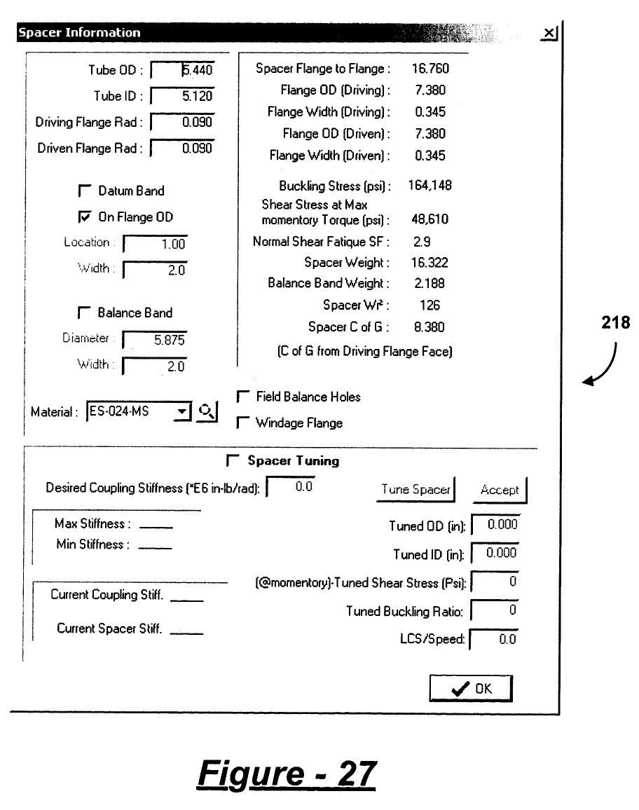

Turning to FIG. 27, form 218 allows spacer modifications and has a tuning module that allows the user to automatically tune the spacer to a desired stiffness. Types of data communicated and/or collected by controls of form 218 are detailed in Table 15.

TABLE 15

| FIELD | VALUE | MAX | MIN |
|---|---|---|---|
| Tube OD | 6.62 | 2 digits 3 decimals | 0.5 |
| Tube ID | 6.25 | 2 digits 3 decimals | 0.5 and <Tube |
| | | | OD |
| Driving flange | 0.12 | 1 digits 2 decimals | Non zero |
| Rad. | | | |
| Driven flange | 0.12 | 1 digits 2 decimals | Non zero |
| Datum band | Check box | Both location and | |
| | (Activates | width must be | |
| | Location and | entered is this is | |
| | width) | checked | |
| On flange OD | Check box | | |
| | (Deactivates | | |
| | Location and | | |
| | width) | | |
| Location | 1 | 1 digits 2 decimals | Non zero |
| Width | 2 | 1 digits 1 decimals | Non zero |
| Balance band | Check box | | |
| | (Activate the | | |
| | next fields) | | |
| Diameter | Auto-Manual | 2 digits 2 | >Tube OD |
| | 7.15 | decimals, max + | |
| | | tube OD * 1.25 | |
| Width | Auto - 1.5 | 2 digits 2 | 0.25 |
| | Manual | max = 0.2* | |
| | | decimals, | |
| | | (spacer | |
| | | flange to flange | |
| | | distance − dvg | |
| | | spacer flange | |
| | | width − dvn spacer | |
| | | flange width | |
| Material | List box | | |
| Field balance | Check box | | |
| holes | | | |
| Windage flange | Check box - | | |
| | Disable | | |
| Spacer Tuning | Check box | | |
| | (Activates fields | | |
| | below) | | |
| Desired | Current stiffness- | 3 digits 1 decimal | Auto calculated |
| coupling | Auto-Manual | Max auto | |
| stiffness | | calculated | |
| Tune Spacer | Calculated and | | |
| | populates fields | | |
| | below | | |
| *Bug | Fields after this | Should be labels | |
| | on form should | | |
| | not be editable | | |
| Tuned buckling | | 8 digit - At least 1 | |
| ratio | | decimal | |
| Accept | Transfers values | | |
| | to active design | | |

In some embodiments, a “Field Balance Holes” control may not be available for MS or MP couplings. In additional or alternative embodiments, logical limits can be placed on the number of significant digits on buckling stress and shear labels, such as three significant digits.

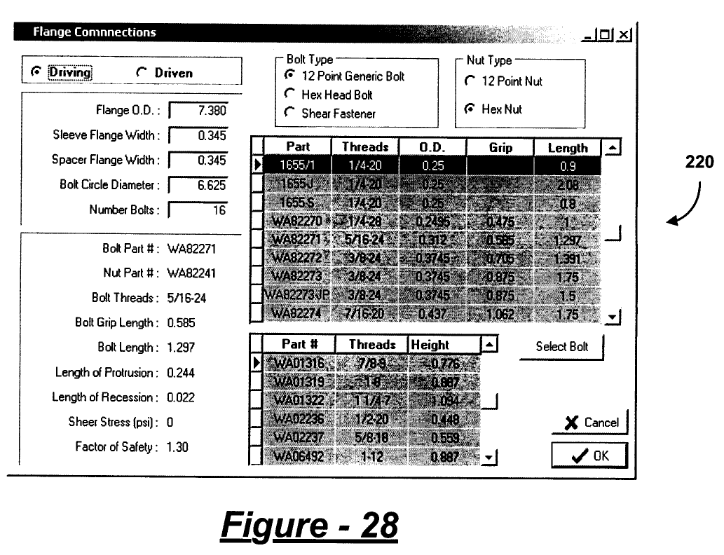

Turning to FIG. 28, form 220 allows the user to modify flange connections. Types of data communicated and/or collected by form 220 are detailed in Table 16.

TABLE 16

| FIELD | VALUE | MAX | MIN |
|---|---|---|---|
| Flange OD | 12.28 | 2 digits 3 decimals | >Spacer OD |
| Rigid/Sleeve | 0.535 | 1 digit 3 decimals | Non zero |
| flange width | | | |
| Adapter/Spacer | 0.535 | 1 digit 3 decimals | Non zero |
| Flange width | | | |
| Bolt circle dia | 9.5 | 2 digit 3 decimals | >Spacer OD |
| | | Less than flange | |
| | | OD | |
| Number Bolts | 14 | 2 digits | 2 |
| Bolt type | Radio group | | |
| Nut type | Radio group | | |
| (above radio | | | |
| group selections | | | |
| control the | | | |
| database | | | |
| snapshots below) | | | |
| Select bolt | Selects the bolt | | |

Form intelligence causes changes in the bolt selection to change the nut selection and visa versa.

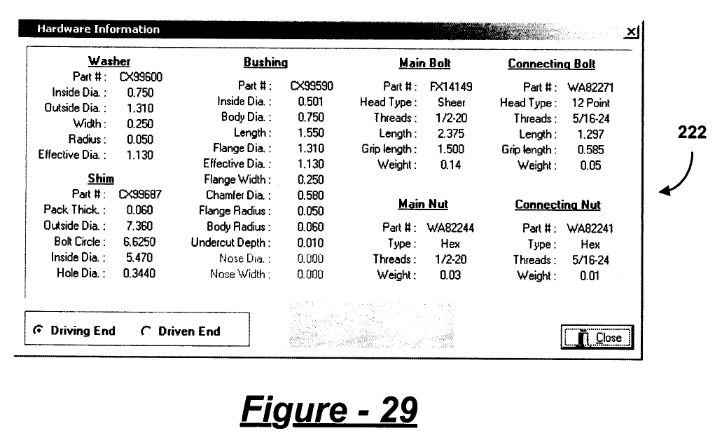

Turning to FIG. 29, form 222 serves as a display page communicating data about current values in the active design to the user. Active design is not modified.

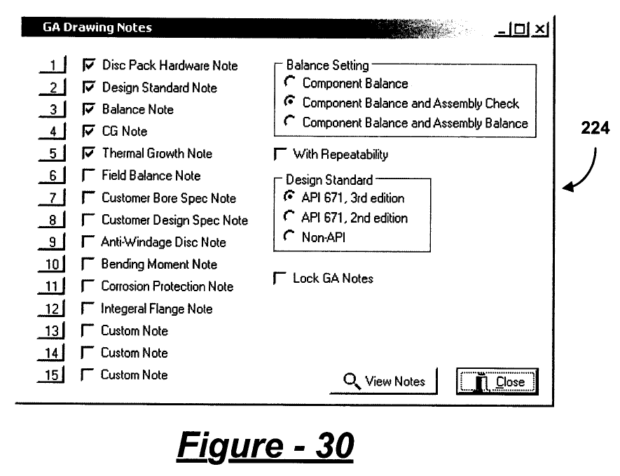

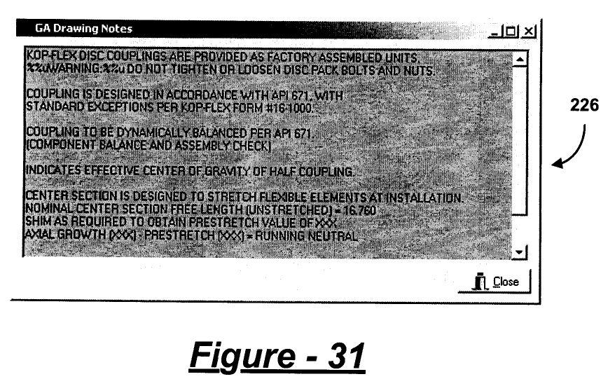

Turning to FIGS. 30 and 31, forms 224 and 226 allow the user to add standard and custom notes to the coupling drawing. Numbered command buttons in form 224 can be provided to allow the user to change a standard note, which can be select for inclusion using a corresponding checkbox. A Lock GA notes Checkbox can be provided to allow the user to retain any modifications that are made to the standard notes. A View Notes command button allows the user access form 226, which displays all currently selected notes. Balance Setting & Design Standard radio buttons can changes the standard notes available for user selection and/or modification.

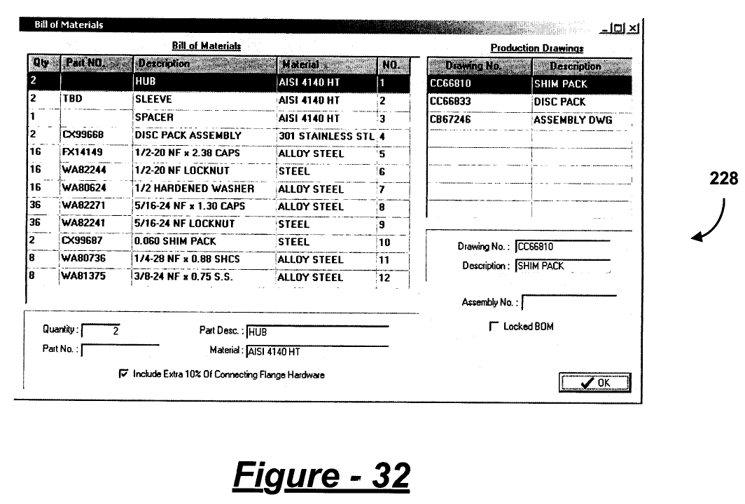

Turning to FIG. 32, form 228 displays the bill of material created by CAP for the active design. The user can modify entries by clicking on them and making changes in four text fields provided on the page. The user can also add/modify production drawings using similar controls on another region of form 228. Most of the fields are Automatic, but can be modified manually if required. A control can also be provided for locking the BOM, an maintaining the custom changes to the bill of materials. Another control can allow the user to add an additional percentage to the bill, such as ten percent, or a percentage defined by the user. Another control can allow the user to specify a part number for the coupling assembly. It is also envisioned that the user can be allowed to add parts to the main BOM section.

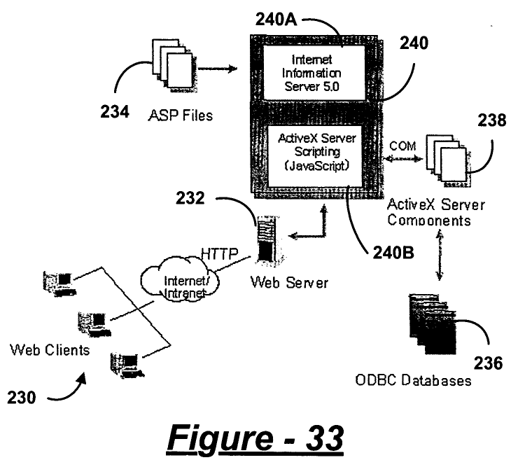

Turning to FIG. 33, an entity relationship diagram illustrates one implementation of the user interface components described above that can be accessed and employed by a user. In particular, web clients 230 access web server 232 over communications network 234, such as the Internet or an intranet. Server 232 accesses ASP files 234 and ODBC databases 236 to obtain Active X server components 238, and provide the components using Internet Information Server 5.0 240A and Active X Server Scripting 240B. Specifically, a user accesses the web-embodiment of the coupling design system's Internet coupling automation program (iCAP) application's ASP page on an IIS-based web site, through the web browser. The user is able to view the page if the user has the necessary access rights.

The business logic is encapsulated into business service objects. These objects are implemented separately as ActiveX controls. They are responsible for implementing all actions required by the business processes like data/image extraction, mathematical calculations and updating databases with new data.

The ASP page 240 has a mixture of HTML and Java Script code. Creation of drawings and saving of drawings are accomplished using server-side scripting. The ActiveX (COM Automation) interface in AutoCAD software is used to generate the necessary AutoCAD drawings. The plug-in, such as AutoCAD Express Viewer is used to view the AutoCAD drawings.

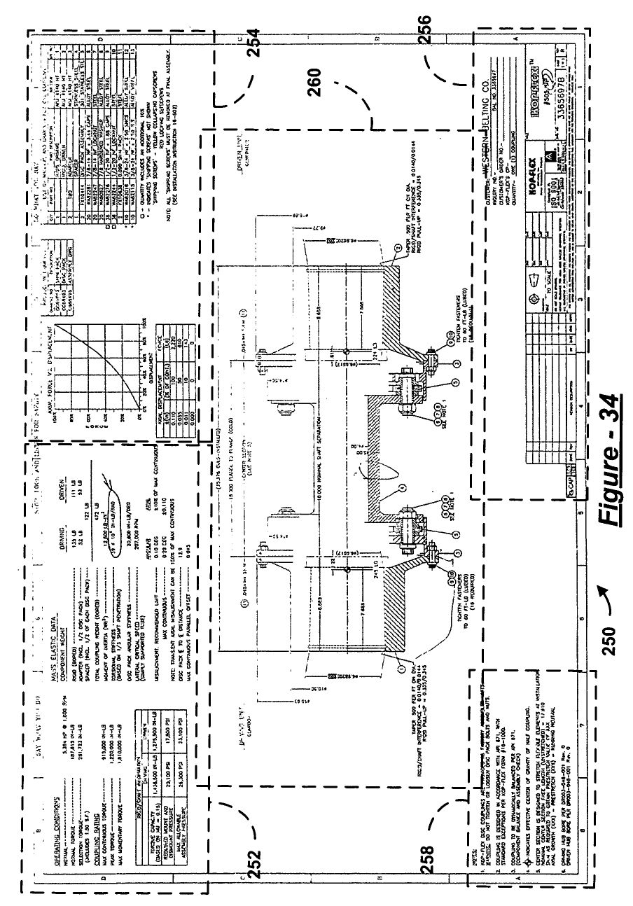

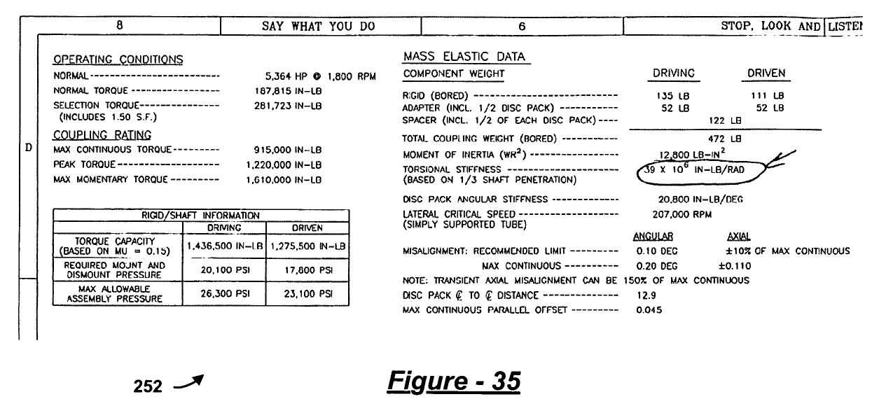

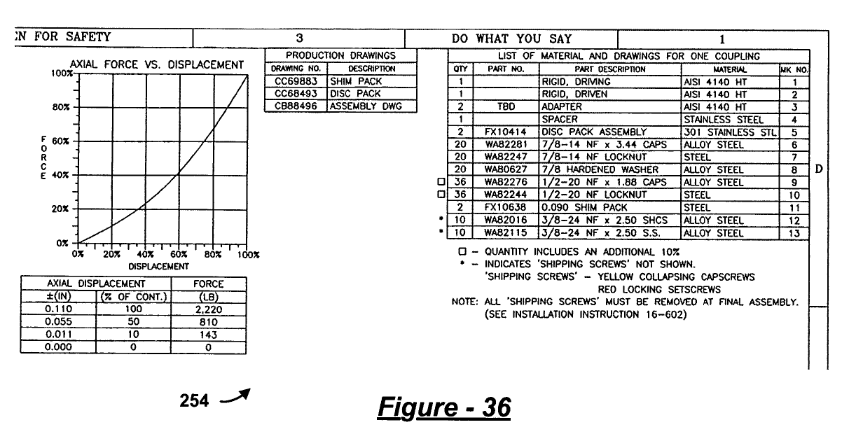

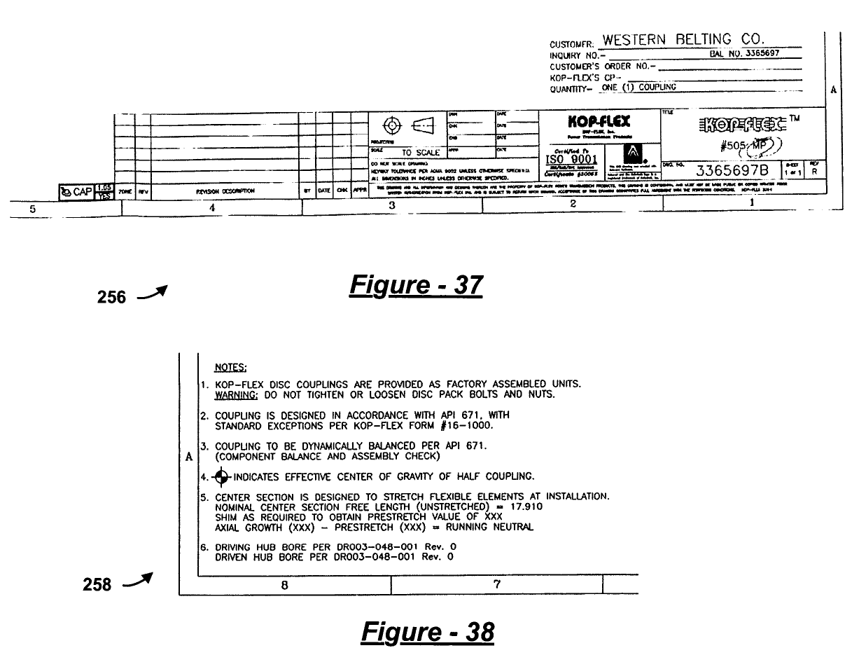

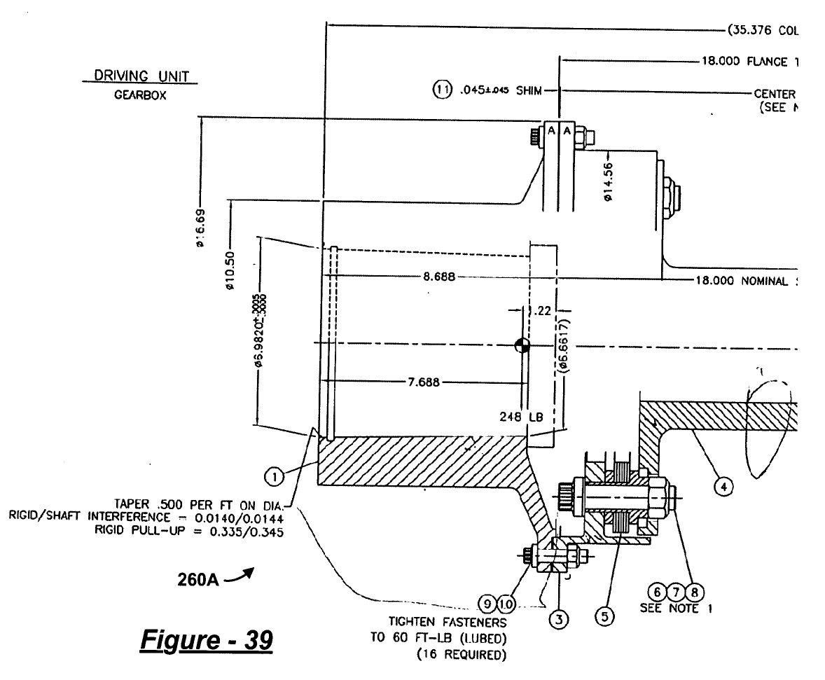

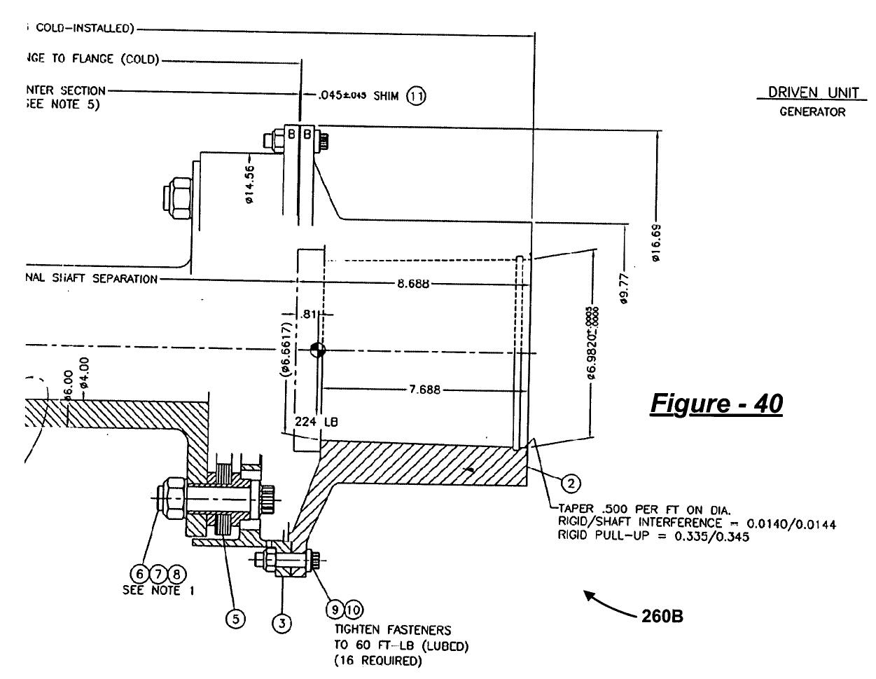

Turning now to FIGS. 34-40, a CAD drawing 250 produced according to the present invention is suitable for use in manufacture and/or assembly of a coupling designed according to the present invention. Referring to FIG. 34, the CAD drawing 250 has several regions, including a design data region 252, a list of materials region 254, a customer-client information region 256, a notes region 258, and a drawing region 260. For example, design data region 252 detailed in FIG. 35 includes operating conditions and performance data as determined from data supplied in response to predefined service factor queries, and based on coupling material selections, component supplementations and/or modifications, and other data collected and/or calculated according to the present invention. Also, list of materials region 254 detailed in FIG. 36 includes a library of coupling components generated based on the design obtained according to the present invention. Further, information region 256 detailed in FIG. 37 includes identifying information about the customer, the drawing, and the manufacturer. Yet further, notes region 258 detailed in FIG. 38 includes notes selected by the user as options for supplementing the design according to the present invention. Further still, drawing region 260 partially detailed in FIG. 39 at 260A and partially detailed in FIG. 40 at 260B illustrates the coupling design obtained according to the present invention to scale, including accurate dimensions for coupling components in a proper arrangement. As can be appreciated, the driving and driven rigids and adapters and the spacer were designed by the coupling automation program to meet the user-defined specifications. Other coupling components such as nuts, washers, shims, etc. are off the shelf components.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A system for designing a set of coupling components for coupling driving and driven shafts, comprising:
an input module that provides a user interface for entering user input including one or more design parameters and/or user selections;
a coupling selection and design module that attempts to design at least one set of coupling components that meet said design parameters based on said user selections; and
an output module that generates a coupling design specification file based on a selected one of said sets of coupling components from said coupling selection and design module.

2. The system of claim 1 further comprising a computer aided design (CAD) tool that receives said coupling design specification file and that automatically generates detailed assembly drawings therefrom.

3. The system of claim 1 wherein when a plurality of sets of coupling components meet said design parameters, said coupling selection and design module prompts a user to select one of said sets of coupling components.

4. The system of claim 1 wherein when said coupling selection and design module fails to generate any sets of coupling components that meet said design parameters, said coupling selection and design module prompts said user to adjust at least one of said user selections and/or said design parameters.

5. The system of claim 1 wherein said coupling selection and design module designs said coupling components by specifying at least one of dimensions of said coupling components and/or coupling types that meet said design parameters.

6. The system of claim 1 wherein said coupling components include at least one of an adapter, a spacer and/or a rigid.

7. The system of claim 1 wherein said coupling components include off the shelf components including at least one of a nut, a bolt, a spacer and/or a shim.

8. The system of claim 1 further comprising a configuration options module that performs selection of post design options based on user input.

9. The system of claim 8 wherein said post design options include at least one of an anti windage disc pack option, a desired stiffness option and/or a spacer material option.

10. The system of claim 9 wherein said output module generates the coupling design specification file based on the selection of one of said post design options.

11. The system of claim 1 further comprising a manual design module that performs manual modifications to one or more coupling components based on user input.

12. The system of claim 11 wherein said output module generates said coupling design specification file based on said manual modifications.

13. A method for designing a set of coupling components for coupling driving and driven shafts, comprising:
providing a user interface for entering user input including one or more design parameters and/or user selections;
attempting to design at least one set of coupling components that meet said design parameters based on said user selections; and
generating a coupling design specification file based on a selected one of said sets of coupling components.

14. The method of claim 13 further comprising automatically generating detailed assembly drawings from said coupling design specification file.

15. The method of claim 13 further comprising prompting a user to select one of a plurality of sets of coupling components that meet said design parameters.

16. The method of claim 13 further comprising prompting said user to adjust at least one of said user selections and/or said design parameters when there are no sets of coupling components that meet said design parameters.

17. The method of claim 13 further comprising designing said coupling components by specifying at least one of dimensions of said coupling components and/or coupling types that meet said design parameters.

18. The method of claim 13 wherein said coupling components include at least one of an adapter, a spacer and/or a rigid.

19. The method of claim 13 wherein said coupling components include off the shelf components including at least one of a nut, a bolt, a spacer and/or a shim.

20. The method of claim 13 further comprising performing selection of post design options based on user input.

21. The method of claim 20 wherein said post design options include at least one of an anti-windage disc pack option, a desired stiffness option and/or a spacer material option.

22. The method of claim 20 wherein said output module generates said coupling design specification file based on said selection of one of said post design options.

23. The method of claim 13 further comprising performing manual modifications to one or more coupling components based on user input.

24. The method of claim 11 further comprising generating said coupling design specification file based on said manual modifications.
